(19) United States
(12) Patent Application Publication
(10) Pub. No.: US 2012/0110405 A1
(43) Pub. Date: May 3, 2012

(54) COMMUNICATION DEVICE

(75) Inventors: Kiyoshi TOSHIMITSU, Tokyo (JP); Tomoya Tandai, Kawasaki-shi (JP); Ryoko Matsuo, Tokyo (JP)

(73) Assignee: KABUSHIKI KAISHA TOSHIBA, Tokyo (JP)

(21) Appl. No.: 13/310,153

(22) Filed: Dec. 2, 2011

Related U.S. Application Data
(63) Continuation of application No. PCT/JP2009/002483, filed on Jun. 3, 2009.

(51) Int. Cl. H04W 24/00; H04L 12/26

(52) U.S. Cl. 714/748; 370/242

(57) ABSTRACT

According to one exemplary embodiment, a communication device includes: a receiver which receives a frame including data, a first error detection code for detecting an error of the data, a sequence number of the data, and a second error detection code for detecting an error of the sequence number; a first detector which detects the error of the data using the first error detection code; a second detector which detects the error of the sequence number using the second error detection code; a generator which generates an acknowledgement frame having maximum sequence number information regarding a maximum sequence number in a frame for which the error of the sequence number is not detected, and acknowledgement information representing whether there is an error for data in each frame of which the sequence number being equal to or less than the maximum sequence number; and a transmitter which transmits the acknowledgement frame.

### CROSS REFERENCE TO RELATED APPLICATION(S)

This is a Continuation Application of PCT Application No. PCT/JP2009/002483 filed on Jun. 3, 2009, which was published under PCT Article 21(2) in Japanese; the entire contents of which are incorporated herein by reference.

### FIELD

The present invention relates to wireless communication.

### BACKGROUND

There is a technique in which a plurality of frames (MPDU: Mac Protocol Data Unit) are received, and then a reception device returns an acknowledgement frame (for example, BlockAck) representing a reception state (success or failure) of the received frame after a frame interval period (for example, SIFS: Short Interval Frame Space). Reduction of the frame interval period has been studied for high throughput.

Since the reception device needs to complete the reception process of the plurality of frames and transmission preparation of the acknowledgement frame in the frame interval period, the process speed is improved through the high speed of an operation clock, but there is a problem that power consumption is increased.

Meanwhile, when the reception device arbitrarily determines the timing of returning the acknowledgement frame, the power consumption of the reception device can be lowered. However, there is a problem that a transmission device cannot recognize what is a frame for which the transmission is acknowledged, by a method of returning the acknowledgement frame described above.

### BRIEF DESCRIPTION OF THE DRAWINGS

Exemplary embodiments of the present invention will be described in detail based on the following figures, wherein:

FIG. 1 is a diagram showing a configuration of a communication device according to a first embodiment;

FIG. 2 is a diagram showing a frame;

FIGS. 3A and 3B are diagrams showing a frame;

FIG. 4 is a diagram showing an acknowledgement frame;

FIGS. 5A and 5B are diagrams showing a sequence;

FIG. 6 is a diagram showing an acknowledgement frame;

FIG. 7 is a diagram showing an acknowledgement frame;

FIG. 8 is a diagram showing an acknowledgement frame;

FIGS. 9A and 9B are diagrams showing a sequence and an acknowledgement frame;

FIG. 10 is a diagram showing an AD converter;

FIG. 11 is a diagram showing a receiver; and

FIG. 12 is a diagram showing a buffer.

### DETAILED DESCRIPTION OF THE EXEMPLARY EMBODIMENTS

According to one exemplary embodiment, a communication device includes: a receiver which receives a frame including data, a first error detection code for detecting an error of the data, a sequence number of the data, and a second error detection code for detecting an error of the sequence number; a first detector which detects the error of the data using the first error detection code; a second detector which detects the error of the sequence number using the second error detection code; a generator which generates an acknowledgement frame having maximum sequence number information regarding a maximum sequence number in a frame for which the error of the sequence number is not detected, and acknowledgement information representing whether or not there is an error for data in each frame of which the sequence number being equal to or less than the maximum sequence number; and a transmitter which transmits the acknowledgement frame.

Hereinafter, embodiments of the invention will be described. In addition, hereinafter, a communication device transmitting a data frame is referred to as a transmission side transmission device, and a communication device (communication device transmitting an acknowledgement frame) receiving a data frame is referred to as a reception side reception device.

### First Embodiment

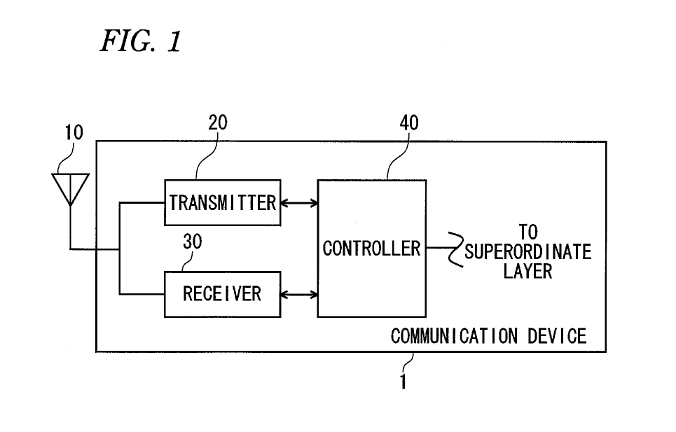

FIG. 1 is a diagram showing a communication device 1 according to a first embodiment. The communication device 1 includes an antenna 10, a transmitter 20, a receiver 30, and a controller 40. The transmitter 20 and the receiver 30 perform a process relating to a physical layer. The transmitter 20 and the receiver 30 perform an amplification process of a signal transmitted to and received from the antenna 10, a frequency conversion process, and an AD/DA conversion process. The controller 40 performs a process relating to a MAC layer.

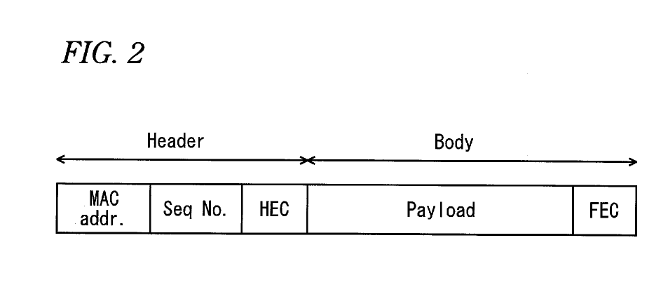

FIG. 2 is a diagram showing a frame (MPDU: Mac Protocol Data Unit). The frame includes a header and a body. The header includes at least information (hereinafter, referred to as a sequence number (Seq No.: SN) as an example) for identifying the frame, and information (hereinafter, referred to as HEC (Header Error Correction)) for detecting an error of the sequence number. The header may further include a reception destination address (MAC address: MAC addr.) for identifying a reception destination of the frame, or a transmission source address for identifying a transmission source of the frame. The HEC may detect errors of the reception destination address and the transmission source address, as well as the sequence number. The body includes payload that is information (data) transmitted to the communication device 1 of the reception destination, and information (hereinafter, referred to as FEC (Frame Error Correction)) for detecting an error of the payload. In addition, the HEC and FEC may be codes capable of detecting an error of a target, for example, CRC (Cyclic Redundancy Check).

The controller 40 detects an error of the sequence number or the like using the HEC, and detects an error of the payload using the FEC when the frame is received. The controller 40 performs the following operation according to whether or not there is error detection (reception state of frame: 4 cases) of the header (sequence number or the like) and the body (payload) using the HEC and the FEC.

(Case 1) When an error is not detected in both of the header and the body (the header and the body is successfully received), the controller 40 reports that the frame is successfully received, by the acknowledgement frame (for example, BlockAck) to the communication device 1 of the transmission source.

(Case 2) When an error is not detected in the header and an error is detected in the body (only the header is successfully received), the controller 40 reports that the frame corresponding to the sequence number can be received but the body cannot be successfully received, by the acknowledgement frame to the communication device 1 of the transmission source.

(Case 3) When an error is detected in the header and an error is not detected in the payload (only the body is successfully received), and (Case 4) when errors are detected in the header and the body (the reception of the header and the body fails), the sequence number or the like may be erroneous, and the controller 40 cannot recognize what is the sequence number of the received frame and does not transmit the acknowledgement frame.

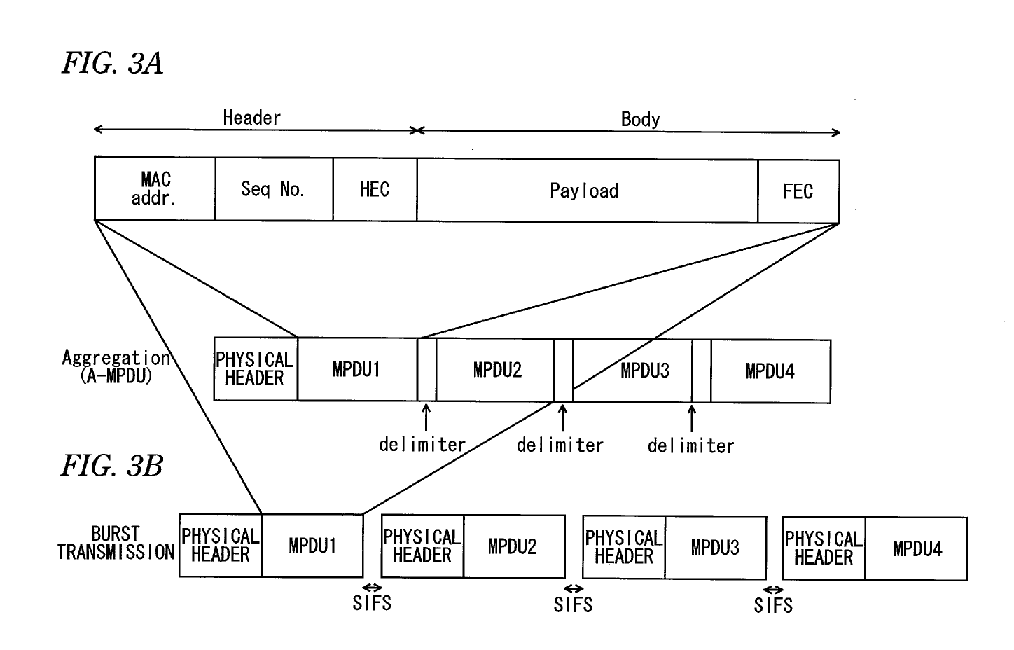

FIG. 3A is a diagram showing one PPDU (Physical Protocol Data Unit) having a plurality of MPDU, and FIG. 3B is a diagram showing PPDU continuously transmitted at a predetermined interval (for example, SIFS). Each of MPDU 1 to 4 is a frame shown in FIG. 2. The transmitter 20 adds a physical header (Preamble for frame synchronization) to MPDU or A-MPDU to generate PPDU. The transmitter 20 performs carrier sensing, and transmits the PPDU in a case of an idle state during a predetermined period (sum of fixed time and random time).

The controller 40 describes the time (communication period until the frame exchange sequence is completed) necessary for the following transmission and reception into a field (for example, Duration field) describing a period of reserving a band including each MPDU, and reserves a frequency band (wireless channel). In addition, before performing the transmission and reception of data, the reservation of the frequency band may be performed using a signal (RTS: Request to send) for requesting to send and a signal (CTS: Clear to send) for allowing to send.

When the PPDU having the A-MPDU is transmitted, the controller 40 inserts a delimiter representing division of the MAC frames and collects the plurality of MPDU to generate the A-MPDU. When the PPDU having the A-MPDU is received, the controller 40 divides (deaggregates) the A-MPDU using the delimiter and extracts each MPDU. The controller 40 may add information (length or the like of each MPDU) for dividing the MPDU to the physical header or the like to generate the A-MPDU without using the delimiter, and the A-MPDU may be divided using the information.

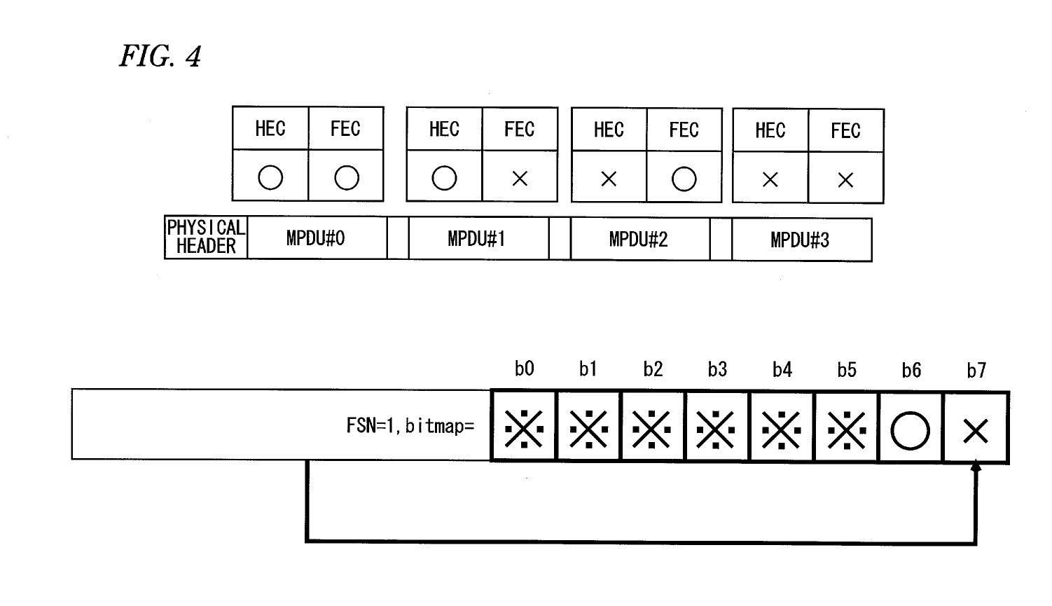

FIG. 4 is a diagram showing the acknowledgement frame (BlockAck: BA). It is an example (b0 to b7) in which the acknowledgement information (bitmap) representing success or failure of the reception of each MPDU is 8 bits.

The acknowledgement frame includes the maximum sequence number information and the acknowledgement information. The maximum sequence number information may be any information by which it is possible to identify the maximum sequence number of the frames with no detected error in the header as the plurality of frames received by the reception side communication device 1. The acknowledgement information may be any information when it is information representing whether or not there is an error for data of sequence numbers equal to or less than the sequence number represented by the maximum sequence number information.

In the example shown in FIG. 4, the maximum sequence number information is FSN (Final Sequence Number). The FSN is the maximum sequence number of the frames with no detected error in the header as the plurality of frames received by the reception side communication device 1. Hereinafter, the MPDU of the sequence number n is referred to as MPDU#n. When the FSN is n, the bitmap b7 represents success or failure of the reception of the MPDU#n, the bitmap b6 represents success or failure of the reception of the MPDU#n−1, . . . , and the bitmap b0 represents success or failure of the reception of the MPDU#n−7.

FIG. 4 shows the acknowledgement frame when the reception side communication device 1 receives the A-MPDU including the MPDU of the sequence numbers 0, 1, 2, and 3. The controller 40 successfully receives both of the header and the body of the MPDU#0, successfully receives only the header of the MPDU#1, successfully receives only the body of the MPDU#2, and does not successfully receive both of the header and body of the MPDU#3.

The controller 40 receives the MPDU, and then generates the acknowledgement frame. The controller 40 describes the maximum sequence number “1” into the FSN, describes the reception failure (NG: X) into the bitmap b7 (MPDU#1), and describes the reception success (OK: O) into the bitmap b6 (MPDU#0), in the MPDU successfully receiving the header. The controller 40 may describe the past reception status into the bitmaps b0 to b5, and may be Don't Care (*). The same value as that of one of OK and NG is set for Don't Care. Since it is general that the NG is set for Don't Care, FIG. 4 shows an example in which the controller 40 sets the NG to the bitmaps b0 to b5 when any MPDUs are not received before the A-MPDU.

Even when the NG is described in the bitmaps b0 to b5, the communication device 1 transmitting the A-MPDU stores the sequence number of the transmitted frame, and thus it is possible to neglect the NG of the bitmaps b0 to b5.

As described above, the maximum sequence information is described in the acknowledgement frame, and the transmission side communication device 1 can thereby determine the sequence number of the MPDU when the acknowledgement information (bitmap) for the MPDU is included in the acknowledgement frame.

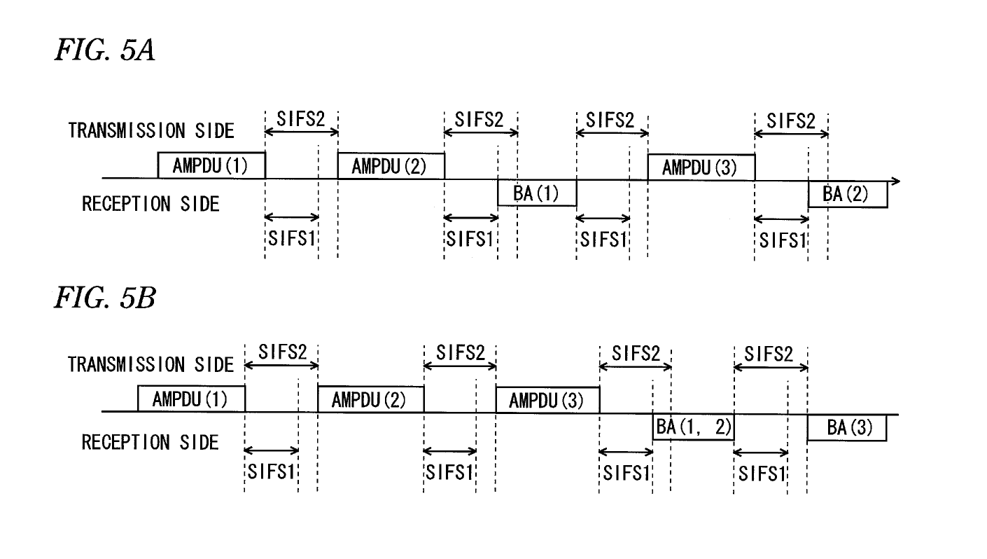

FIGS. 5A and 5B are diagrams showing sequences. The A-MPDU (1) has the MPDU of SN=0, 1, 2, and 3. The A-MPDU (2) has the MPDU of SN=4, 5, 6, and 7. The A-MPDU (3) has the MPDU of SN=8, 9, 10, and 11. The SIFS2 period is longer than the SIFS1 period.

In the case that the acknowledgement frame is returned, the reception side communication device 1 (reception device 1) transmits the acknowledgement frame, after the SIFS1 period is elapsed after the data frame is received, when any frame is not received, during the SIFS1 period after the data frame is received. The transmission side communication device 1 (transmission device 1) transmits the next data frame, after the SIFS2 period is elapsed from the transmission of the data frame or the reception of the acknowledgement frame, when any frame (for example, acknowledgement frame) is not received during the SIFS2 period from the transmission of the data frame or the reception of the acknowledgement frame.

In the example shown in FIG. 5A, the reception device 1 does not return anything since transmission preparation of the BlockAck (1) for the A-MPDU (1) is not completed at the timing when the SIFS1 period is elapsed from the reception of the A-MPDU (1). The transmission side communication device 1 transmits the A-MPDU (2) after the SIFS2 period is elapsed. The reception device 1 transmits the BlockAck (1) after the SIFS1 period is elapsed since the transmission preparation of the BlockAck (1) is not completed at the timing of receiving the A-MPDU (2). A value represented by the maximum sequence number information of the BlockAck (1) is any one of the sequence numbers 0 to 3 included in the A-MPDU (1). The transmission device 1 can recognize that the reception status of the A-MPDU (2) is not included in the BlockAck (1) when the value represented by the maximum sequence number information of the BlockAck (1) is the value (equal to or less than 3) included in the A-MPDU (1). For this reason, it is possible to prevent the transmission device 1 from erroneously retransmitting the A-MPDU (2).

In the example shown in FIG. 5B, the reception device 1 receives the A-MPDU (3), then integrates the acknowledgement information for the A-MPDU (1) and the A-MPDU (2) into the BlockAck (1, 2), and returns the BlockAck (1, 2). The value represented by the maximum sequence number information of the BlockAck (1, 2) is any one of the sequence numbers 0 to 7 included in the A-MPDU (1) and the A-MPDU (2). The transmission device 1 can recognize that the reception status of the A-MPDU (3) is not included in the BlockAck (1, 2) when the value represented by the maximum sequence number information of the reception of the BlockAck (1, 2) is the value (4 to 6) included in the A-MPDU (2). For this reason, it is possible to prevent the transmission device 1 from erroneously retransmitting the A-MPDU (3).

When an error of all the headers included in the A-MPDU (2) is detected in the reception device 1, the value represented by the maximum sequence number information of the BlockAck (1, 2) is a value (equal to or less than 3) included in the A-MPDU (1). The transmission device 1 erroneously determines that the reception status of the A-MPDU (2) is not included in the BlockAck (1, 2). However, generally, since there are many cases where the header length is short and is transmitted in a modulation type and an encoding type of a low rate which is not easily affected by the communication circumstances, a case of erroneous determination caused by the error of all the header parts of the A-MPDU is rare.

As described above, in the communication device 1 according to the first embodiment, the maximum sequence number information is included in the acknowledgement frame, and thus it is possible to prevent the unnecessary data frame on the transmission side from being retransmitted even when the acknowledgement frame (BlockAck) for the data frame (A-MPDU) is transmitted at an arbitrary timing on the reception side.

Since it is possible to transmit the acknowledgement frame at the arbitrary timing on the reception side, it is not necessary to perform a reception process such as the determination of success or failure of the reception of the data frame and the generation of the acknowledgement frame during the frame interval period (SIFS or the like) after receiving the data frame (MPDU, A-MPDU). Therefore, it is possible to reduce process performance required on the reception side, and thus it is possible to reduce power consumption.

During the frame interval period (SIFS or the like), it is not necessary to perform the reception process of the data frame on the reception side. Therefore, it is possible to further shorten the frame interval period (SIFS1, SIFS2, or the like), and thus it is possible to improve effective throughput.

(Modification Example 1 of First Embodiment)

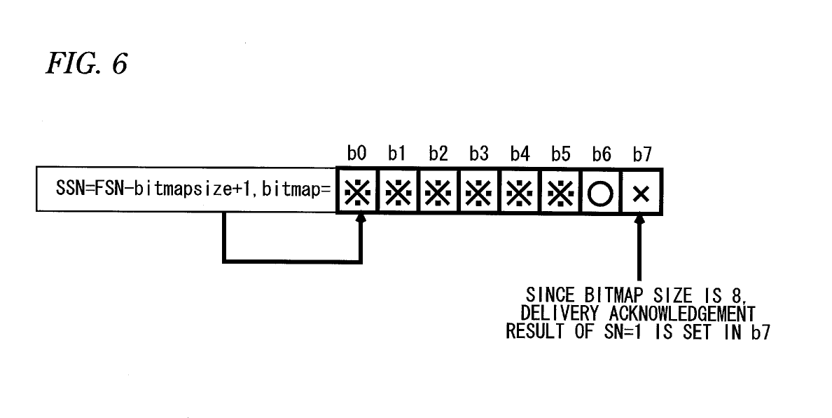

In the first embodiment, the acknowledgement frame is FIG. 4, but may be FIG. 6.

FIG. 6 is a diagram showing the acknowledgement frame. Herein, the reception device 1 receives the same A-MPDU as shown in FIG. 4, and the header of each MPDU and success or failure of the reception of the body are the same as shown in FIG. 4. The acknowledgement frame shown in FIG. 6 is different in that the FSN is not described but SSN (Starting Sequence Number) is described as the maximum sequence number information, as compared with the acknowledgement frame shown in FIG. 4. The description method of the acknowledgement information (bitmap) is the same.

In the SSN, a value of subtracting a bitmap size (bitmap_size=“8”) from the FSN (“1”) and adding “1” is described. For this reason, the transmission device 1 can identify the FSN, that is, the maximum sequence number, from the SSN of the frames with no detected error in the header as the plurality of frames received in the reception side communication device 1. The value of the bitmap size may be a fixed value, and may be determined at the time of connection between the transmission device 1 and the reception device 1.

A specific value of the SSN shown in FIG. 6 becomes 1018, for example, when the sequence number is represented by 10 bits (0 to 1023), depending on the number of bits representing the sequence number. The bitmaps b0 to b5 correspond to the reception status (Don't Care) of the MPDU of the sequence numbers 1018 to 1023.

(Modification Example 2 of First Embodiment)

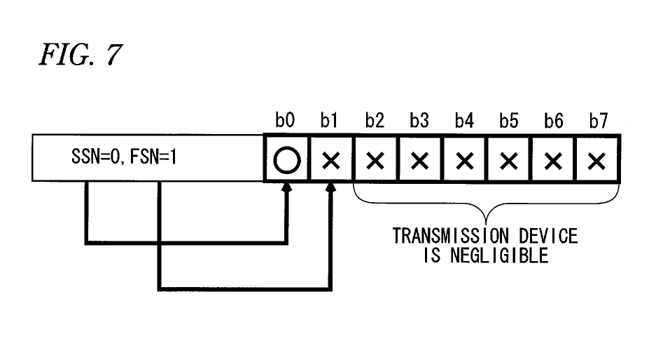

In the first embodiment, the acknowledgement frame is FIG. 4, but may be FIG. 7.

FIG. 7 is a diagram showing the acknowledgement frame. Herein, the reception device 1 receives the same A-MPDU as shown in FIG. 4, and the header of each MPDU and success or failure of the reception of the body are the same as shown in FIG. 4. The acknowledgement frame shown in FIG. 7 is different in description of the SSN that is minimum sequence number information and a method of describing the acknowledgement information (bitmap) in addition to the FSN that is the maximum sequence number information, as compared with the acknowledgement frame shown in FIG. 4.

The minimum sequence number information may be any information if it is possible to identify the minimum sequence number of the frames with no detected error in the header, as the plurality of frames received in the reception side communication device 1.

The FSN is the maximum sequence number (“1”) of the frames with no detected error in the header as the plurality of frames received in the reception side communication device 1. The SSN is the minimum sequence number (“0”) of the frames with no detected error in the header as the plurality of frames received in the reception side communication device 1.

The acknowledgement information (bitmap) includes the reception status of the MPDU from the SN (SSN=0) represented by the minimum sequence number information to the SN (FSN=1) represented by the maximum sequence number information. The bitmap b0 represents the reception status of the MPDU of “SSN=0”. The bitmap b1 represents the reception status of the MPDU of “SSN+1=FSN=1”. The bitmap b2 and subsequent become Don't Care.

As described above, since the minimum sequence number information is included in the acknowledgement frame as well as the maximum sequence number information, only the reception status of the MPDU from the SN (SSN=0) represented by the minimum sequence number information to the SN (FSN=1) represented by the maximum sequence number information is effective information, it is possible to neglect the information described in the bitmap of the bitmaps b2 to b7. Therefore, it is possible to prevent the data frame from being unnecessarily retransmitted.

In addition, when a difference between the sequence number represented by the maximum sequence number information and the sequence number represented by the minimum sequence number information is larger than the maximum number of reception statuses of the MPDU included in the acknowledgement frame, ““minimum sequence number information”+“maximum number of reception statuses of MPDU included in acknowledgement frame”−1” is set to the maximum sequence number information.

(Modification Example 3 of First Embodiment)

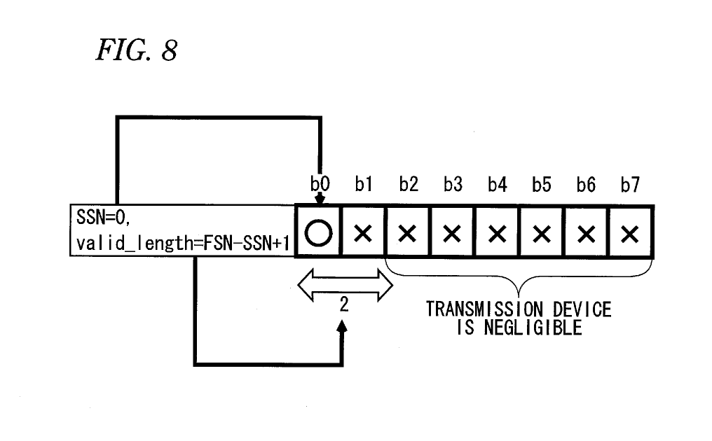

In Modification Example 2 of the first embodiment, the acknowledgement frame is FIG. 7, but may be FIG. 8.

FIG. 8 is a diagram showing the acknowledgement frame. Herein, the reception device 1 receives the same A-MPDU as shown in FIG. 4, and the header of each MPDU and success or failure of the reception of the body are the same as shown in FIG. 4. The acknowledgement frame shown in FIG. 8 is different in having a valid bit length (Valid Length) instead of the FSN, as compared with the acknowledgement frame shown in FIG. 7. A method of describing the acknowledgement information (bitmap) is the same as shown in FIG. 7.

The valid bit length is a value obtained by subtracting the SN represented by the minimum sequence information from the SN represented by the maximum sequence information and adding “1”. For this reason, the transmission device 1 can identify the FSN, that is, the maximum sequence number, from the minimum sequence number information (SSN) and the valid bit length from the frames with no detected error in the header as the plurality of frames received in the reception side communication device 1.

As described above, the minimum sequence number information and the valid bit length (=maximum sequence number information) is included in the acknowledgement frame, only the reception status of the MPDU from the SN (SSN=0) represented by the minimum sequence number information to the SN (FSN=1) represented by the maximum sequence number information is effective information, it is possible to neglect the information described in the bitmap of the bitmaps b2 to b7, and thus it is possible to prevent the data frame from being unnecessarily retransmitted.

(Modification Example 4 of First Embodiment)

In the first embodiment, the NG is described in the acknowledgement information (bitmap) in any case where the header is successfully received and the body is erroneous, and where the header is erroneous. However, in the acknowledgement information (bitmap), the OK/NG of the header and the OK/NG of the body may be separately reported.

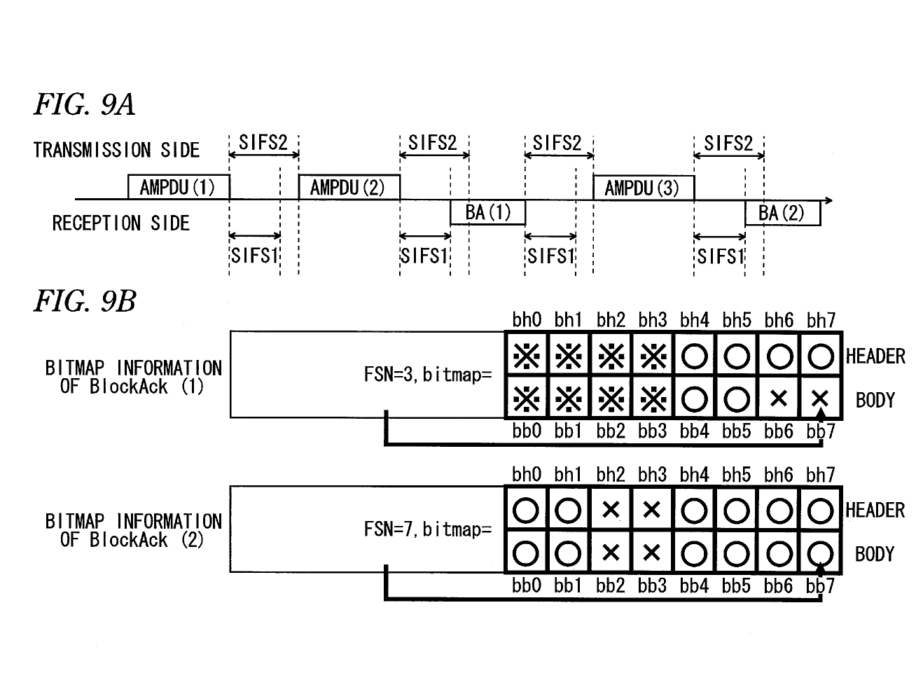

FIG. 9A is a diagram showing a sequence. The AMPDU (1) has the MPDU of SN=0, 1, 2, and 3. The A-MPDU (2) has the MPDU of SN=4, 5, 6, and 7. The A-MPDU (3) relates to retransmission, and has the MPDU of SN=2 and 3. The reception device 1 successfully receives the header of the MPDU of SN=0, 1, 2, and 3 and the body of SN=0 and 1 at the time of receiving the AMPDU (1), and detects an error in the body of SN=2 and 3. The reception device 1 successfully receives the header and the body of the MPDU of SN=4, 5, 6, and 7 at the time of receiving the AMPDU (2).

The transmission device 1 transmits the AMPDU (1) and the AMPDU (2). Then, the reception device 1 returns BA (1) for the AMPDU (1). Then, the transmission device 1 receives the BA (1), and retransmits the AMPDU (3). Then, the reception device 1 returns BA (2) for the AMPDU (1). In this case, the transmission device 1 is not clearly notified whether the BA (2) represents only the reception status of the AMPDU (1) or represents the reception status in which the AMPDU (1) and the AMPDU (3) relating to the retransmission are put together.

FIG. 9B is a diagram showing the acknowledgement frame. The acknowledgement frame includes the maximum sequence number information, the acknowledgement information (bitmaps bh0 to bh7) for the header of each MPDU, and the acknowledgement information (bitmap bb0 to bb7) for the body of each MPDU. The bitmap bhn represents success and failure of the reception of the header of the MPDU of the sequence number “FSN+n−7”. The bitmap bbn represents success and failure of the reception of the body of the MPDU of the sequence number “FSN+n−7”.

Since the header has high error resistance, there is a high probability that the reception device 1 successfully receives the header. For this reason, in the reception device 1, when the acknowledgement information of all the headers of the MPDU included in the AMPDU is NG, it can be determined that the reception process of the AMPDU is not performed yet.

When it is determined whether the BA (2) represent only the reception status of the AMPDU (1) or represents the reception status in which the AMPDU (1) and the AMPDU (3) relating to the retransmission are put together, and when it is reported that an error is detected in the header of all the MPDU included in the AMPDU (3), the transmission device 1 determines that the BA (2) represents only the reception status of the AMPDU (1). Meanwhile, when the header of several MPDU included in the AMPDU (3) is successfully received, the transmission device 1 determines that the BA (2) represents the reception status in which the AMPDU (1) and the AMPDU (3) relating to the retransmission are put together.

In the example shown in FIGS. 9A and 9B, since the header of all the MPDU (SN=2 and 3) included in the AMPDU (3) is not successfully received, the transmission device 1 determines that the reception result of the A-MPDU (3) relating to the retransmission is not reflected in the BlockAck (2), and does not retransmit the MPDU constituting the A-MPDU (3).

Since the reception device 1 does not receive the retransmission of the MPDU of SN=2 and 3 when transmitting the BlockAck (1), the reception status of the A-MPDU (1) is described in the BlockAck (1) for the MPDU of SN=2 and 3. Since the reception device 1 receives the retransmission of the MPDU of SN=2 and 3 and the reception process of the AMPDU (3) relating to the retransmission is not completed when transmitting the BlockAck (2), it is described in the BlockAck (2) that both of the header and the body of the MPDU of SN=2 and 3 are not successfully received, to prevent the erroneous retransmission of the transmission device 1. The reception device 1 sets at least the body part to OK and the header part to OK or NG in the reception status of the MPDU of SN=0 and 1. With such a configuration, the transmission device 1 can recognize that the reception device 1 does not complete the reception process of the MPDU of SN=2 and 3, and can estimate a delay degree of the process.

Although the sequence in which the data and the acknowledgement frame are asynchronous is described with reference to FIGS. 4, 5, and 9, they may be synchronous. In addition, sequences in which the data and the acknowledgement frame are synchronous and asynchronous may be provided together.

(Modification Example 5 of First Embodiment)

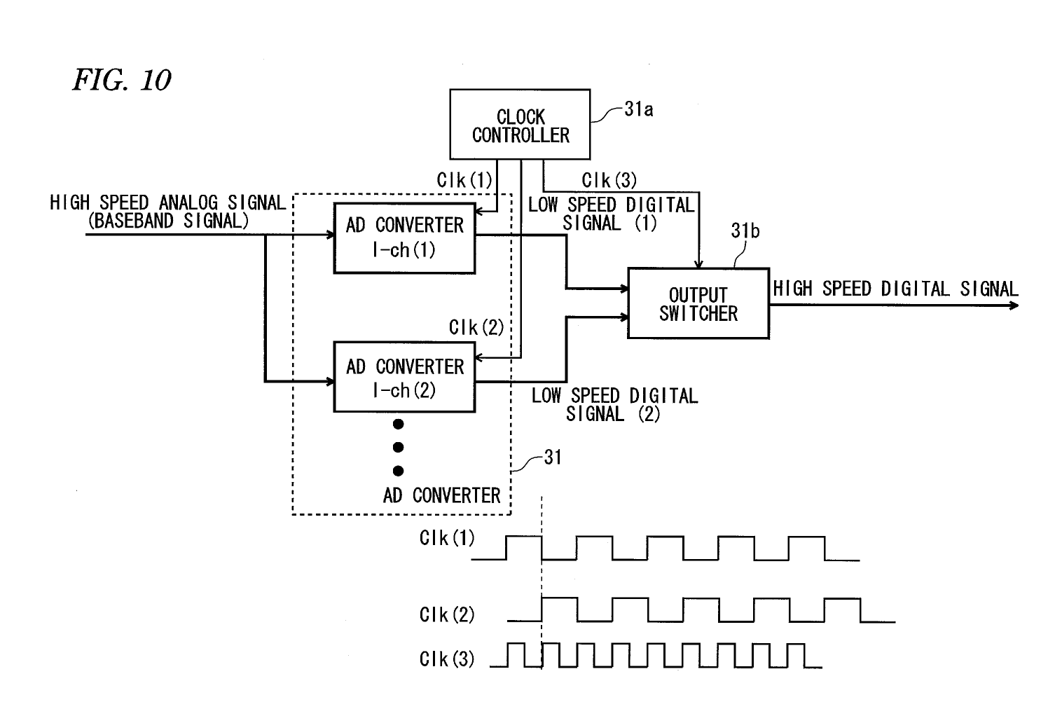

FIG. 10 is a diagram showing an analog/digital (AD) converter 31 of the receiver 30 of the communication device 1 according to Modification Example 5 of the first embodiment. The AD converter 31 of the receiver 30 includes an AD converter I-CH (1), an AD converter I-CH (2), a clock controller 31a, and an output switcher 31b. When the receiver 30 of the communication device 1 receives a wireless signal through the antenna 10, first, the receiver 30 converts a frequency of the wireless signal from an RF frequency band into a baseband frequency. Then, the receiver 30 converts the analog signal converted into the baseband, into a digital signal using the AD converter 31.

The analog signal is a signal transmitted in an actual wireless section, and an amplification process and a frequency conversion process of the analog signal in the receiver 30 are performed in real time. Hereinafter, the baseband signal is converted into two channels (I channel and Q channel), then is subjected to AD conversion in separate (two) AD converters (I channel side: I-CH (1) and I-CH (2), and is subjected to a digital signal process. The baseband signal may be not orthogonal in the analog, may be subjected to AD conversion by an analog-digital converter, and then may be orthogonally demodulated in the digital signal process.

When the baseband signal is converted into two orthogonal channels and then the AD conversion is performed, the number of AD converters N is an even number, and the number of digital processors is M equal to or more then N/2. In addition, the input signal into one digital processor is two inputs of I channel and Q channel.

In the AD conversion of the general communication device, oversampling is performed, and thus a sampling frequency is set high. To realize high speed transmission, a higher speed AD converter is necessary. The receiver 30 has two or more AD converters (I channel side: I-CH (1) and I-CH (2)) for each of the I channel and the Q channel, and thus it is possible to perform the high speed AD conversion. FIG. 10 shows an example of a configuration in which the baseband signal (high speed analog signal) for the I channel is subjected to the AD conversion by two AD converters I-CH (1) and I-CH (2). In addition, the baseband signal (high speed analog signal) for the Q channel is also subjected to the AD conversion by two AD converters Q-CH (1) and Q-CH (2) (not shown).

The sampling intervals of four AD converters I-CH (1), I-CH (2), Q-CH (1), and Q-CH (2) for the I channel and the Q channel are the same. Sampling points of two AD converters I-CH (1) and I-CH (2) for the I channel are shifted from each other by ½ of the sampling interval. For example, when clocks obtained by inverting the sampling clock to each other are supplied to two AD converters I-CH (1) and I-CH (2) for the I channel, it is possible to shift the sampling points from each other by ½ of the sampling interval. The same is applied to two AD converters Q-CH (1) and Q-CH (2). Two AD converters Q-CH (1) and Q-CH (2) for the Q channel are synchronized with two AD converters I-CH (1) and I-CH (2) for the I channel.

As described above, the number of AD converters is 2×K (K is a natural number), and thus the sampling frequency of the AD converter 31 can be 1/K. When the sampling frequency is lowered, it is easy to mount the AD converter 31, and thus it is possible to realize low power consumption. The output switcher 31b performs sampling at the sampling frequency of 1/K output from two AD converters for the I channel, and alternately switches the sampled and digitalized low speed digital signals (1) and (2) by the original sampling frequency, and outputs them as high speed digital signals.

In addition, although the number of AD converters is 2×K (for example, K=2) in Modification Example 5 of the first embodiment, only a part of AD converters of K AD converters 31 for the I channel and a part of AD converters K of the AD converters 31 for the Q channel may be operated until edge detection or power measurement of the wireless signal is performed. In the AD converter which stops operating, the supply of power is stopped or the clock controller 31a stops the supply to the clock.

In such a manner, it is possible to reduce power consumption of waiting the wireless signal, it is possible to perform the high speed AD conversion process after the reception process of the wireless signal is started, by operating 2×K AD converters 31 after the edge detection of the wireless signal, and thus it is possible to keep communication quality.

In addition, a low speed digital processor may be provided between the output switcher 31b and the output of the AD converter operating even at the waiting time of the wireless signal in the plurality of AD converters 31 for the I and Q channels. With such a configuration, in the low speed digital processor, the process relating to the edge detection or the power measurement may not be performed, and it is possible to further reduce the power consumption.

In addition, the low speed digital processor may be further provided between the output switcher 31b and the output of the plurality of AD converters 31 for the I and Q channels. With such a configuration, it is possible to process the low speed sampling result in each low speed digital processor. Particularly, this method is effective when the transmission device 1 performs mapping of signals under the assumption that the reception device 1 performs the reception process described above.

When the low speed digital processor is further provided between the output switcher 31b and the output of the AD converter 31 for the I and Q channel, the output of one AD converter (for example, I-CH (1)) is distributed to two lower speed digital processors, and the process may proceed in parallel in two lower speed digital processors. As the operation speed of the digital processor gets lower, it is possible to lower the operation clock and the operation voltage, and thus it is possible to further lower the power consumption.

(Modification Example 6 According to First Embodiment)

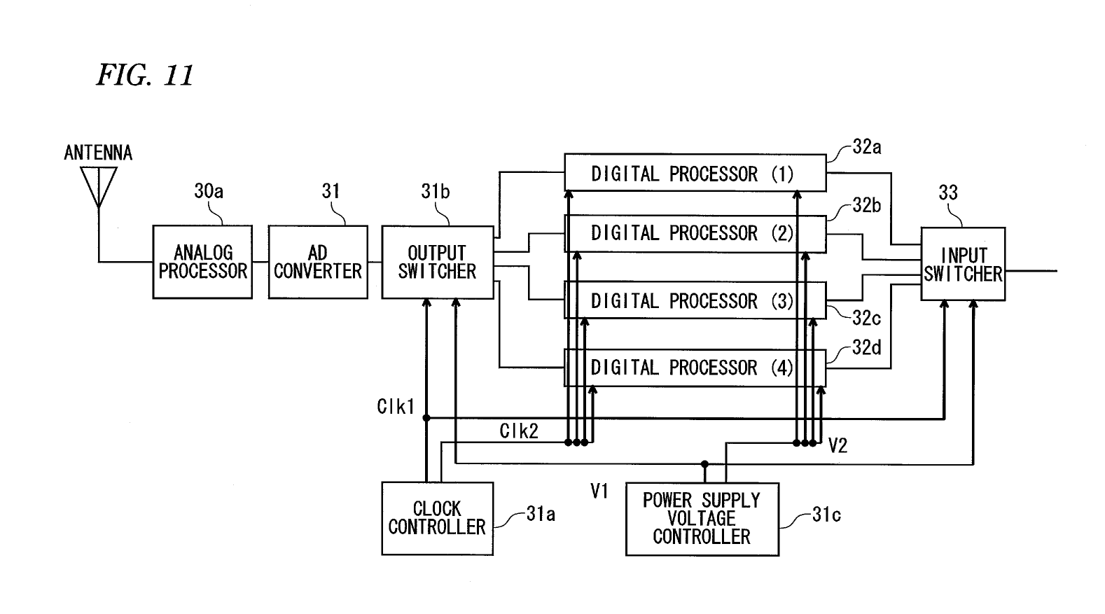

FIG. 11 is a diagram showing the receiver 30 of the communication device 1 according to Modification Example 6 of the first embodiment. In Modification Example 5 according to the first embodiment, the AD converters 31 are provided in parallel, but the digital signal units 32 performing the signal process after the AD conversion may be provided in parallel. The receiver 30 includes an analog processor 30a, an AD converter 31, a clock controller 31a, an output switcher 31b, a power supply voltage controller 31c, digital processors 32a to 32d, and an input switcher 33.

The digital processors 32a to 32d set the operation speed to be a low speed to lower the operation clock and the operation voltage, and thus it is possible to lower power consumption.

The number of digital processors depends on the degree of lowering of the clock frequency. For example, when the clock frequency is 1/L times, the number of digital processors is necessary L times. Although a chip area of the digital processors is increased, there is a great merit of low power consumption based on the lowering of the clock frequency and the operation voltage since the size of LSI has been reduced by advance of the latest semiconductor process.

The analog processor 30a, the output switcher 31b, the digital processors 32a to 32d, and the input switcher 33 may be configured by different LSIs, and may be configured by one LSI. The digital processors 32a to 32d may be configured by one LSI. As described above, the receiver 30 is configured by the plurality of chips, and thus costs may be increased. However, functional blocks having a large influence on wireless performance such as the antenna 10 can be disposed at a position where high performance can be easily obtained.

In the related art, the analog signal line is made long, and thus expansion of disposition of the antenna 10 is obtained. However, in high frequency wireless with large loss on the analog signal, it is more preferable to elongate the analog signal line than to elongate the digital signal line. It is conceivable to elongate the signal line of the baseband signal before the AD converter 31, but an influence on the baseband signal is large and the digital signal line is elongated according to an apparatus (for example, an apparatus with a lot of noise) provided with the communication device 1.

A higher speed digital processor may be provided between the AD converter 31 and the output switcher 31b. With such a configuration, the high speed digital processor between the AD converter 31 and the output switcher 31b performs a preamble process of a wireless frame such as frame synchronization, and the plurality of low speed digital processors 32a to 32d between the output switcher 31b and the input switcher 33 can perform a decoding process such as Viterbi decoding.

In addition, in this case, the clock (first clock) supplied to the high speed digital processor between the AD converter 31 and the output switcher 31b is higher in frequency than the clock (second clock) supplied to the plurality of low speed digital processors 32a to 32d between the output switcher 31b and the input switcher33. More specifically, when there are N blocks of low speed digital processors, the second clock frequency is 1/N of the first clock frequency.

The power supply voltage (first power supply voltage) supplied to the high speed digital processor between the AD converter 31 and the output switcher 31b is higher than the power supply voltage (second power supply voltage) supplied to the plurality of low speed digital processors 32a to 32d between the output converter 31b and the input switcher 33. The power consumption of the digital processors 32a to 32d is substantially proportional to [clock frequency F×capacitance C×operation voltage V²]. Although the clock frequency is 1/N, a circuit scale is N times and thus F×C is unchanged. However, the power consumption may be reduced in order of square by lowering the operation voltage. For example, when the operation voltage of 1.2 V is lowered to 0.8 V, the power consumption may be equal to or less than a half as (0.8/1.2)×(0.8/1.2)=4/9.

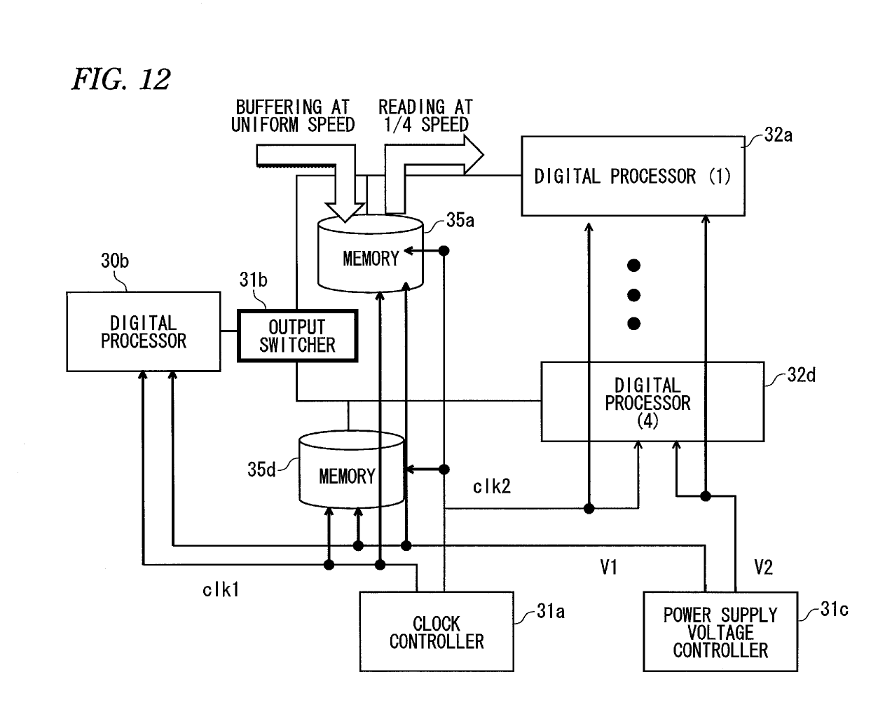

FIG. 12 is a diagram showing data transmission between the high speed digital processor 30b between the AD converter 31 and the output switcher 31b, and the plurality of low speed digital processors 32a to 32d between the output switcher 31b and the input switcher 33. When the output of the high speed digital processor 30b is distributed to the plurality of low speed digital processors 32a to 32d, it may be distributed to the low speed digital processors 32a to 32d different for each wireless signal, and the process of one wireless signal may be distributed to the plurality of low speed digital processors 32a to 32d.

Buffer memories 35a to 35d for absorbing a speed difference are provided between the high speed digital processor 30b and the low speed digital processors 32a to 32d. Writing into buffer memories 35a to 35d is performed at a processing speed (the same speed) of the high speed digital processor 1. Reading from the buffer memories 35a to 35d is performed at a processing speed (low speed) of the low speed digital processors 32a to 32d. When the processing speed of the high speed digital processor 30b is N times the processing speed of the low speed digital processors 32a to 32d, the writing speed to the buffer 35a to 35d is N times the reading speed from the buffer 35a to 35d.

For this reason, 2 kinds of clocks supplied to the buffer memories 35a to 35d are prepared. It is necessary to supply the first clock (clk1) and the second clock to the buffer memories 35a to 35d. When the buffer memories 35a to 35d are provided in the same block as the low speed digital processors 32a to 32d, the first power supply voltage (V1) and the second power supply voltage (V2) are supplied. When the buffer memories 35a to 35d are provided in the same block as the higher speed digital processor 30b, the first power supply voltage (V1) is supplied.

(Retransmission Process in First Embodiment)

The transmission device 1 specifies the MPDU retransmitted from the reception status of each MPDU represented in the acknowledgement frame. The MPDU retransmitted by the transmission device 1 is the MPDU which cannot be successfully received in the reception device 1. However, in specifying the MPDU retransmitted by the transmission device 1, it is necessary to recognize whether the acknowledgement frame is to report that the reception of the MPDU fails in the reception device 1 or the reception process is not completed in the reception device 1.

When the transmission device 1 receives the acknowledgement frame having at least maximum sequence number information shown in FIGS. 4, 6, 7, 8, and 9, it is specified by the MPDU retransmitting the MPDU, in which the reception success on the reception device 1 side cannot be confirmed, of the transmission-completed MPDU of the sequence number or less represented by the maximum sequence number information.

The transmission device 1 can further specify the MPDU retransmitted by the following method. When the A-MPDU is transmitted, the transmission device 1 stores the sequence number of at least one MPDU included in the A-MPDU, for each A-MPDU. In addition, the transmission device 1 may store the sequence numbers of all the MPDU included in the A-MPDU. When the transmission device 1 stores (manages) the sequence numbers of all the MPDU included in the A-MPDU, process load of management is increased, but it is possible to detect the occurrence of an error of the MPDU header with high precision. The transmission device 1 stores and manages the sequence number of the transmitted MPDU. In the example shown in FIG. 5A, the transmission device 1 stores that the A-MPDU (1) having the MPDU of SN=0 to 3 and the A-MPDU (2) having the MPDU of SN=4 to 7.

The reception device 1 generates and transmits the BlockAck for each A-MPDU. In the example shown in FIG. 5A, although the reception process of a part of the MPDU (for example, SN=0 to 3) included in one A-MPDU (for example, A-MPDU (1)) is not completed, the reception device 1 describes several acknowledgement information of the MPDU of SN=0 to 3 included in the A-MPDU (1) and does not transmit the BlockAck.

The transmission device 1 receives the BlockAck under the condition described above. When the sequence number represented by the maximum sequence number information included in the BlockAck is the sequence number of the MPDU included in the A-MPDU (1), the transmission device 1 analyzes that the reception device 1 completes the reception process of the A-MPDU (1). When the maximum sequence number information included in the BlockAck is the sequence number of the MPDU included in the A-MPDU (2), the transmission device analyzes that the reception device 1 performs the reception process of the A-MPDU (2).

For example, in the example shown in FIGS. 5A and 5B, when the sequence number represented by the maximum sequence number information of the BlockAck is “5”, the transmission device recognizes the reception status from the acknowledgement information of the BlockAck for the MPDU of the sequence number equal to or less than 5, and it is possible to recognize that an error is detected in the header for the MPDU of the sequence numbers 6, 7, and 8 included in the A-MPDU (2). The transmission device 1 retransmits the MPDU which is not successfully received by the reception device 1 of the MPDU of the sequence number equal to or less than 5 and the MPDU of the sequence numbers 6, 7, and 8.

The transmission device 1 considers that the header is not successfully received in the reception device 1, and retransmits the MPDU more than the sequence number represented by the maximum sequence number information in the A-MPDU including the sequence number represented by the maximum sequence number information as the MPDU included in the A-MPDU. In such a manner, it is possible to improve the efficiency of the retransmission process of the MPDU with the error in the header.

In addition, in a retransmission process in the first embodiment, the same is applied to the burst transmission of continuously transmitting the plurality of MPDU at a predetermined interval (for example, SIFS). The transmission device 1 stores and manages the sequence number of the transmitted MPDU by a unit (burst transmission group) of MPDU group continuously transmitted to in one transmittable period (TXOP). The reception device 1 generates and transmits the BlockAck by a unit of MPDU group (burst transmission group) continuously transmitted in one transmittable period (TXOP).

The transmission device 1 receives the BlockAck under the operation described above. The transmission device 1 considers that the header is not successfully received in the reception device 1, and retransmits the MPDU more than the sequence number represented by the maximum sequence information in the burst transmission group including the sequence number represented by the maximum sequence number information as the MPDU included in the burst transmission group. In such a manner, it is possible to improve the efficiency of the retransmission process of the MPDU with an error in the header.

### Other Embodiment

While certain embodiment has been described, the exemplary embodiment has been presented by way of example only, and is not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A communication device comprising:
a receiver configured to receive a frame including data, a first error detection code for detecting an error of the data, a sequence number of the data, and a second error detection code for detecting an error of the sequence number;
a first detector configured to detect the error of the data using the first error detection code;
a second detector configured to detect the error of the sequence number using the second error detection code;
a generator configured to generate an acknowledgement frame having maximum sequence number information regarding a maximum sequence number in a frame for which the error of the sequence number is not detected, and acknowledgement information representing whether or not there is an error for data in each frame of which the sequence number being equal to or less than the maximum sequence number; and
a transmitter configured to transmit the acknowledgement frame.

2. The device of claim 1, wherein if the generation of the acknowledgement frame is completed, the transmitter is configured to transmit the acknowledgement frame after a first period is elapsed, and
wherein if the generation of the acknowledgement frame is not completed and a second period longer than the first period has been elapsed after the reception of the frame, the receiver is configured to newly receive frames other than the frame.

3. The device of claim 1, further comprising:
an antenna;
a converter configured to convert the frame received through the antenna by the receiver, from an analog signal to a digital signal;
a first processor configured to execute a first digital signal processing on the digital signal;
a plurality of storage modules configured to store an output signal of the first processor;
a writing module configured to switch and write the output signal of the first processor into any one of the plurality of storage modules; and
a second processor configured to read the output signal of the first processor stored in the one of the plurality of storage modules, and to execute a second digital signal processing on the output signal,
wherein a transmission rate of the signal output from the first processor is higher than a transmission rate of the signal read by the second processor.

4. The device of claim 1, wherein the transmitter is configured to transmit a second physical frame including a plurality of second frames,
wherein the receiver is configured to receive a second acknowledgement frame for the plurality of second frames;
wherein each of the second frames includes data, a first error detection code for detecting an error of the data, a sequence number of the data, and a second error detection code for detecting an error of the sequence number,
wherein the second acknowledgement frame includes maximum sequence number information representing a maximum sequence number in the frames for which the error of the sequence number is not detected on the reception side, and acknowledgement information representing whether or not there is an error for the data of sequence numbers equal to or less than the sequence number represented by the maximum sequence number information, as the plurality of second frames, and
wherein the transmitter is configured to retransmit the second frame of the sequence number higher than the maximum sequence number information included in the second acknowledgement frame in the second frames transmitted from the transmitter.

5. The device of claim 1, wherein the transmitter is configured to transmit the plurality of second frames in one transmittable period,
wherein the receiver is configured to receive the second acknowledgement frame for the plurality of second frames,
wherein each of the second frames includes data, a first error detection code for detecting an error of the data, a sequence number of the data, and a second error detection code for detecting an error of the sequence number,
wherein the second acknowledgement frame includes maximum sequence number information representing a maximum sequence number in the frames for which an error of the sequence number is not detected on the reception side, and acknowledgement information representing whether or not there is an error for the data of sequence numbers equal to or less than the sequence number represented by the maximum sequence number information, as the plurality of second frames, and
wherein the transmitter is configured to retransmit the second frame of the sequence number more than the maximum sequence number information included in the second acknowledgement frame in the second frames transmitted from the transmitter.
